(19) United States
(12) Patent Application Publication
(10) Pub. No.: US 2009/0272287 A1
(43) Pub. Date: Nov. 5, 2009

(54) Cutting Register Control

(75) Inventors: Andreas Klemm, Bad Worishofen (DE); Jan Seebauer, Augsburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/418,271

(22) Filed: Apr. 3, 2009

(30) Foreign Application Priority Data
Apr. 3, 2008 (DE) 10 2008 017 532.3

(51) Int. Cl. B41F 1/34; B41F 13/56

(52) U.S. Cl. 101/485; 101/227

(57) ABSTRACT

A web-fed rotary press having a regulating device. The regulating device is a register roller capable of linear movement installed upstream of at least one drive provided as an upstream actuator, i.e., the drive of the folder lead-in rollers or of the draw rollers near the former lead-in rollers and/or of draw rollers between the slitter and the former lead-in rollers and/or of draw rollers on the full web before it reaches the slitter.

### BACKGROUND OF THE INVENTION

1. Field of the Invention

The present invention relates to a method for adjusting a cutting register in a web-fed rotary press and to a web-fed rotary press configured to implement this method.

2. Description of the Related Art

In the case of web-fed rotary presses, it is known that information printed on the web can be detected by sensors installed along the web, and that, in correspondence with the deviation between the actual position value determined on the basis of the information thus acquired and a predefined nominal value, actuators operated under either open-loop or closed-loop control to act on the substrate web. The goal is to time the arrival of the printed image and thus of the copy to be produced on the cutting cylinder, which cuts the copies from the substrate web, that is, to adjust the cutting register.

The information printed on the web and detected by the sensors can be register marks or the overall printed image itself. The expected time at which the register mark or the overall print image passes by the sensor in question represents the nominal value for the registration. In this conventional case, optical sensors such as cameras, light barriers, or the like are used as sensors. As actuators, register rollers are often used, are moved in linear guides transverse to the direction in which the substrate web travels and by which the distance traveled by the web can be increased or decreased. The drives of rolls at pinch points can also be used as actuators, where the circumferential velocities of the draw rollers along the paper web serve as the manipulated variables of the cutting register control.

In most cases, the sensors are provided near the actuators to keep the distance between the sensor and the actuator as short as possible and thus the tolerances of the control process as narrow as possible. In the known systems, observation and measurement elements and actuators can be provided on the printing couples or on the pairs of draw rollers, etc., downstream of the printing couples. It is also known that measurement and adjusting devices can be installed on the individual strands downstream of the slitter, which divides the web into partial webs, where the drives of strand draw rollers, in front of the former of the folder superstructure, serve as actuators. Another known possibility for observing and adjusting the cutting register exists in the area of the folder on the basis of the angular position of the knife cylinder of the folder, which ultimately defines the timing with which the individual strands which have been gathered into the complete gathered strand are cut into copies and which thus ultimately determines the overall cutting register in the folder.

As mentioned, in the case of the possibilities cited above, the sensors and the actuators are in most cases arranged close to each other. But there are also circuits, especially automatic control cascades, which are known, in which actuators are actuated under the influence of actual values which have been acquired by sensors located a considerable distance away.

Examples of cutting registration controls of the type indicated above can be found in the present applicant's own applications DE 103 35 888, DE 103 35 887, DE 103 35 885, and WO 2005/016806 A1. Here, the paper web is stretched over draw rollers, serving as actuators, upstream of the formers. For this purpose, web observation sensors are provided near the draw rollers, where the control of the cutting register occurs by way of the circumferential velocities of the draw rollers on the individual strands in question and thus by means of the change in the degree to which the individual strand in question is stretched in response to the output values of the web observation sensors. The control in these cases is multi-stage, where the cutting length is also measured on the knife cylinder of the folder and corrected by the angular position of the knives of the knife cylinder. The measurement and adjusting units upstream of the folder serve to eliminate accumulated errors which have occurred up to the measurement site in question, whereas the control on the knife cylinder or on the complete gathered strand by way of a linearly adjustable actuating roller just before the strand reaches the knife cylinder serves to eliminate the cutting register error which occurs between the last measurement position of the strands and the cutting cylinder.

Another system of cutting register control of the general type in question can be found in DE 199 36 291 A1.

### SUMMARY OF THE INVENTION

An object of the present invention is the creation of a method and device for cutting register control or adjustment by which the accuracy of the cutting register of the folder is improved and the overall cutting register error is minimized.

According to one embodiment of the invention, information printed on an individual gathered strand is acquired and the cutting register error of this individual gathered strand is corrected, preferably after it has passed through the folder superstructure and before each of the individual gathered strands are gathered into the complete gathered strand. It is also conceivable, however, that this could be done above the former. The invention is also applicable to the case of a magazine folder superstructure, as long as the web observation step and the corresponding cutting register error correction step are performed on each of the individual gathered strands.

The web-fed rotary press comprises not only a folder and a folder superstructure with a plurality of formers but also at least one sensor and at least one actuator for each individual gathered strand for which a cutting register error of which is to be corrected. The sensor and the actuator are arranged in the folder in an area downstream of the folder superstructure and upstream of the cutting knife cylinder, that is, between the former and the cutting knife cylinder. In addition, a control unit, which is designed to execute the inventive method, is connected to the sensor and to the associated actuator.

By using the inventive cutting register adjustment or control, accuracy of the cutting register is improved significantly compared to known cutting register controls. In the known cutting register controls, a measurement is made at the former inlet, and the cutting register of the partial webs—which may be lying on top of each other—is adjusted correspondingly, the next measurement being is made just upstream of the cutting knife cylinder of the folder after the complete gathered web has been assembled from the individual gathered strands, where the cutting register position is readjusted at the cutting knife cylinder. In the case of large former arrangements, e.g., with balloon formers, it is possible for the cutting register errors of the individual gathered strands to deviate significantly from each other because of differences in the distances that the individual gathered strands travel from the last actuator on the former inlet to the point that the individual strands are laid on top of each other to form the complete gathered web. With the arrangement according to one embodiment, it is possible to eliminate these different cutting register errors of the individual webs which result from the different distances the strands travel on their way through the folder superstructure.

Each individual gathered strand is scanned by a sensor (camera or the like) installed near the actuator and each strand is adjusted by the actuator, preferably a register roller capable of linear movement, in accordance with the determined cutting register error (in the case of a register roller, the error being corrected by changing the length of the web by shifting the register roller in the direction perpendicular to that in which the individual gathered strand in question is running). All of the strands are individually adjusted to a predetermined nominal value for the cutting register, where the nominal value can be preset iteratively by the printer on the basis of empirical values or can originate from higher-level production planning software. The nominal values can also be adapted to take current production conditions into account. Deviations of the acquired actual values from the preset nominal value are then registered at the sensor of the individual gathered strand in question, whereupon the actuator assigned to the individual gathered strand in question is actuated accordingly.

Alternatively, one of the individual gathered strands, optionally also the outer gathered strand of the complete gathered strand, is a reference gathered strand for the other individual gathered strands, so that the correction of the other gathered strands is carried out relative to this reference gathered strand. All of the individual gathered strands are therefore adjusted with respect to the same cutting register serving as a reference value. After the individual gathered strands have been gathered, this cutting register error is then present on all of the individual gathered strands and thus corresponds to the complete gathered strand register error and can therefore be eliminated on the cutting cylinder.

It is especially advantageous to provide actuating signals for at least one of the actuators assigned to the individual gathered strand or to the complete gathered strand and located downstream of the folder superstructure, which are corrected in accordance with previously acquired information printed on the web or webs. This information, which been previously acquired in the known manner from at least one of the plurality of individual gathered strands at a point near the former lead-in rollers and which has been printed on the individual gathered strand in question and/or to use the information previously acquired from at least one individual web between a slitter and the former lead-in rollers and/or to use the information previously acquired from the full web before it has reached the slitter is used as a basis of the actuator signal. It is possible, as a function of the previously acquired information, to decide whether it is permissible to adjust the one or more actuators downstream of the folder superstructure and/or to determine the limits within which such an adjustment may be made.

The advantages are evident when, as in conventional methods or conventional printing presses of the general type in question, actuators are already present at the former inlet for the individual gathered strands entering the former (“supplemental” actuators as defined according to the present invention), and the corresponding sensors are also already present. For, in most cases, the drives of the strand draw rollers are used as the actuators, the circumferential velocity of which can be adjusted faster than the length adjustment at the individual gathered strands by way of the register rollers provided there. The drive motors of the strand draw rollers are preferably held at a working point (a defined standard gain) to prevent an unallowable adjustment of the register rollers on the individual gathered strands, i.e., an adjustment outside the desired adjusting range, from rendering futile the effort to a bring the gain of the strand draw rollers back to the working point (standard gain).

Alternatively to the correction of the actuating signals for the actuators assigned to the individual gathered strands downstream of the folder superstructure by the previously acquired information printed on the strand or web in question, it is possible to use position signals, rotational speed signals, or angle signals of the supplemental actuators. If the drives of the strand draw rollers or other draw roller drives in the path of the partial webs or of the as-yet uncut full web traveling to the folder superstructure are provided as supplemental actuators, it is also advantageous to adjust the drive of the supplemental actuator within predefined limits and to have it return to a working point or standard gain, where, by the use of a regulating device upstream of the drive, any deviation from the standard gain is corrected or an actual gain is returned to the standard gain. Instead of stretching the web by adjusting the drive, a register roller capable of linear movement and thus able to change the length of the web is used as a regulating device.

Instead of or in addition to the actuators on the individual gathered strands, the drive of draw rollers or of the cutting knife cylinder in the area of the complete gathered strand can be controlled to achieve the desired correction in correspondence with the previously acquired information printed on the web or webs.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

Advantageous elaborations are the object of the other subclaims and are explained in greater detail below together with an exemplary embodiment of the invention on the basis of the attached drawings:

FIG. 1 is side view of a folder of a web-fed rotary press with a folder, a folder superstructure, and an upstream turning unit;

FIG. 2 is end view of the folder and folder superstructure of FIG. 1; and

FIG. 3 is schematic diagram of the folder and folder superstructure shown in FIGS. 1 and 2 depict cutting register control according to an advantageous embodiment of the invention.

### DETAILED DESCRIPTION OF THE PRESENTLY PREFERRED EMBODIMENTS

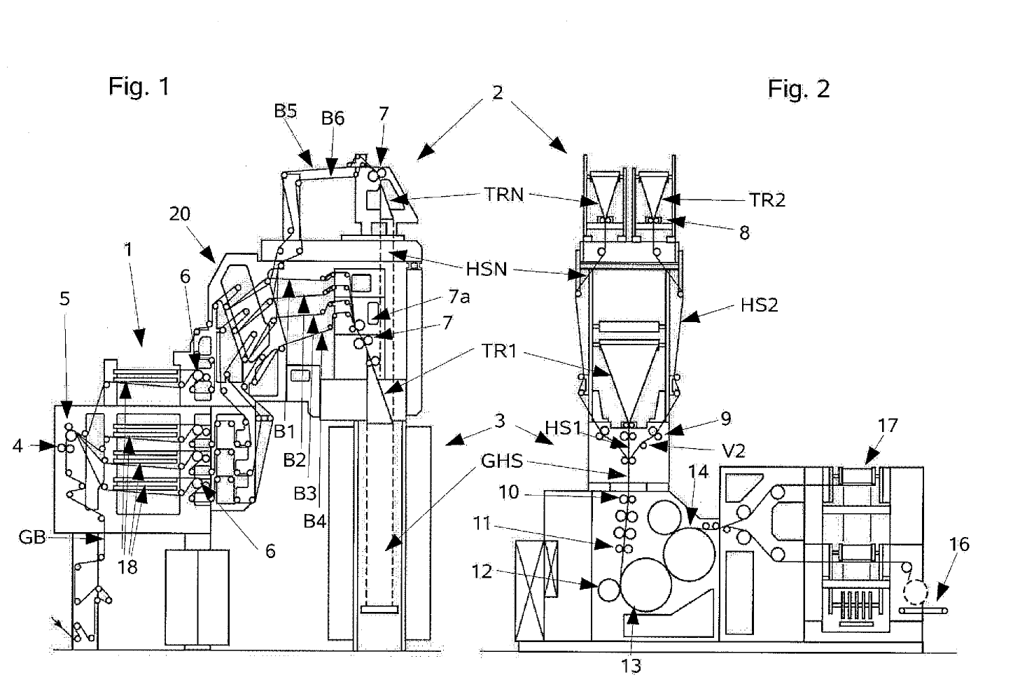

FIGS. 1 and 2 show a folder of a web-fed rotary press with a folder 3, a folder superstructure 2, and an upstream turner bar tower 1. The folders of printing presses are used to form folds in substrates, where, a web-shaped substrate is usually first guided through a former to form a longitudinal fold in the web-shaped substrate before it is cut. Proceeding from the end of the former, the web-shaped substrate is transported over several draw rollers toward a cutting knife cylinder, where, on the cutting knife cylinder, copies are cut from the web-shaped substrate. Then, as the cut web-shaped substitutes continue through the folder, they are folded once in the transverse direction and possibly folded again.

In one embodiment, a slitter 5 is installed upstream of the turner bar tower to divide the full web GB coming from the printing couples (not shown) or intermediate modules (drying, cooling, etc.) into partial webs, i.e., into the partial webs B1, B2, B3, B4 or B1, B2, B5, B6. The slitter 5 is preferably designed as a pair of draw rollers, where there is also a pair of draw rollers 4 provided upstream, which acts on the full web GB.

In the turner bar tower 1, the partial webs B1, B2, B3, B4, B5, B6 are turned by turner bar packages 18 in accordance with the desired printed products and arranged on top of or next to each other and sent in this way to the folder superstructure 2. In the example shown here, either the partial webs B1, B2, B3, B4 are guided one above the other and sent by way of pairs of draw rollers 6 to a double-wide main former TR1 or only the partial webs B1, B2 are so sent, whereas the partial webs B5, B6 are each sent by draw roller pairs 6 to a half-width secondary former.

A linear compensator station 20 is installed between the turner bar tower 1 and the folder superstructure 2. This station contains each partial web passing through in the form of a U-shaped loop. With the help of the compensator rollers, which are moved back and forth, the distance to be traveled by the assigned partial webs B1, B2, B3, B4, B5, B6 is increased or decreased, as a result of which the position of the printed material printed on the web is regulated.

The folder superstructure 2 contains several formers TR1, TR2, TRN; in the present example, it contains three of them, and they produce a continuous longitudinal fold in the gathered strands HS1, HS2, HSN passing over them. A gathered strand HS1 consisting of the partial webs B1, B2, B3, B4, which have been laid on top of each other, is guided via the main former TR1, a gathered strand HS2, HSN is guided via the two secondary formers TR2, TRN. The former noses are flanked by assigned former lead-in roller pairs 7, upstream of which additional draw roller pairs 7a are provided. At the former outlet, another draw group 8 is provided. The former lead-in roller pairs 7 and the draw roller pairs 7a exert tensile force on the gathered strands HS1, HS2, HSN running over their assigned folders TR1, TR2, TRN. The former lead-in roller pairs 7 consist of driven draw rollers.

Individual gathered strands HS1, HS2, HSN are sent to the folder 3, where they are laid on top of each other to form a complete gathered strand GHS before arriving at a cutting knife cylinder 12.

The folder 3 has a cutting knife cylinder 12, a collecting cylinder 13, and a folding jaw cylinder 14. The substrate GHS is moved or guided between the cutting knife cylinder 12, the collecting cylinder (tucker blade cylinder) 13, and a folding jaw cylinder 14. Additional connected rollers such as perforating rollers are operated in synchrony with the cutting knife cylinder 12 and are preferably adjusted when the cutting knife cylinder 12 is adjusted. The knife cylinder can also provide an additional nominal angle value for the drives of the cylinders and belts to be described further below.

To create a transverse fold in the copy separated by the cutting knife cylinder 12, the cutting knife cylinder 12, the collecting cylinder (tucker blade cylinder) 13, and the folding jaw cylinder 14 cooperate such that, upon separation of a copy from the substrate GHS by the cutting knife of the cutting knife cylinder 12, the separated copy is held at the starting edge by a pin device on the tucker blade cylinder and then carried farther onward by rotation of the tucker blade cylinder 13. Of course, other gripping elements besides pin devices can be used.

The separated copy is moved into a defined relative position, suitable for folding, between the tucker blade cylinder 13 and the folding jaw cylinder 14, where, once this relative position has been reached, a tucker blade of the tucker blade cylinder 13 presses the folded area of the copy between opened folding jaws of the folding jaw cylinder 14, whereas the pin device releases the copy. The copy thus held by the folding jaw cylinder 14 is moved onward under rotation of the folding jaw cylinder 14 and transferred to the downstream 3rd folding unit 17 and to the delivery module 16.

Overall, therefore, it is necessary to assemble a greater or lesser number of individual gathered strands HS1, HS2, HSN from partial webs B5, B6 or partial webs B1, B2, B3, B4 into a complete gathered strand GHS and then to cut them by the use of a common knife cylinder 12. As in the case of the known cutting register control systems, the drive motor of the strand draw rollers 7a (not shown in the case of the two secondary formers) upstream of the former lead-in rollers is provided as an actuator for each individual gathered strand HS1, HS2, HSN to compensate, with the help of sensors provided near the motor, for the cutting register error which has accumulated up to that point. This applies in a corresponding manner also to the full web GB, where here the draw rollers 4 can be designed as an actuator with a sensor provided nearby. Alternatively correcting the cutting register for each individual gathered strand HS1, HS2, HSN consists of using linear regulators 20 as actuators. Because these measures are known in and of themselves, the sensors are not shown in FIGS. 1 and 2.

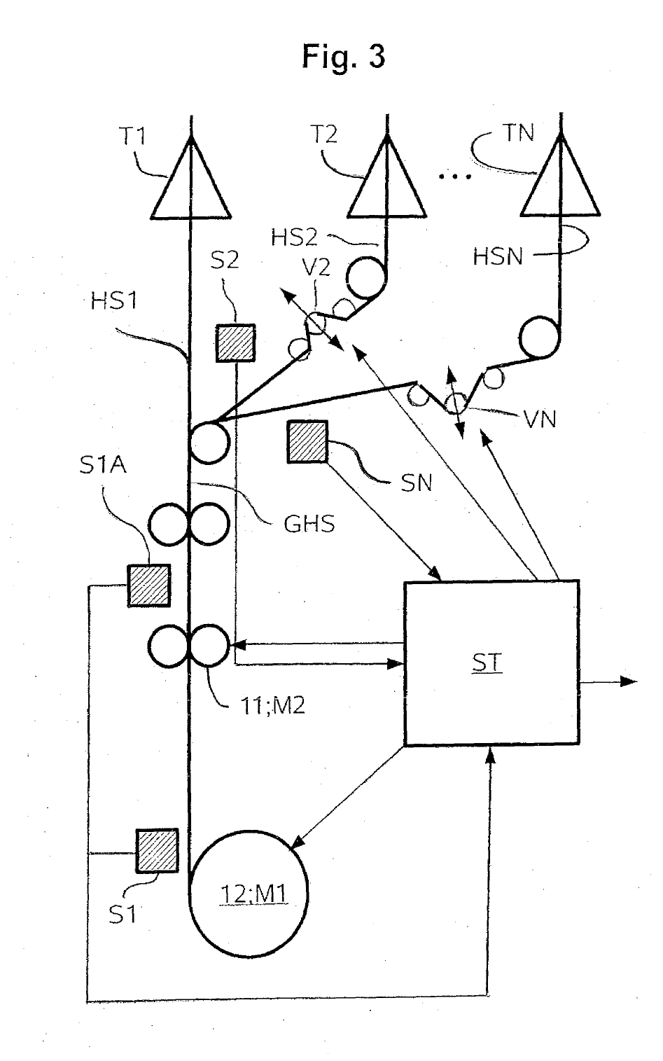

The design of the cutting register control in the area of the folder and the sequence of steps of the cutting register control process in this section of the printing press are explained in greater detail below on the basis of FIG. 3.

The folders T1, T2, TN are shown at the top in FIG. 3, where the three dots between T2 and TN are intended to show that the inventive cutting register control in the present exemplary embodiment is explained on the basis of a configuration with three formers T1, T2, TN, and three individual gathered strands HS1, HS2, HSN, each of which is guided over a former. The invention is not limited to this configuration, however, but can be implemented with any desired number of individual gathered strands HS1, HS2, . . . HSN. Nor is it necessary to guide each individual gathered strand over a former. Instead, the invention can also be realized when one or more of the individual gathered strands bypass the formers or are guided over several formers arranged in a multi-level configuration. These gathered strands can originate from one or more paper webs.

The individual gathered strand HS1 serves in the present embodiment is a reference gathered strand for the other two individual gathered strands HS2, HSN. The cutting register error of the individual gathered strand HS1, which preferably lies on the outside after assembly into the complete gathered strand GHS, is detected by a sensor S1 near the draw rollers 11 at a point located on the cutting cylinder 12. To detect the cutting register error of the two other individual gathered strands HS2 and HSN, corresponding optical sensors S2, SN are arranged at points situated upstream of the point where these individual gathered strands HS2, HSN are assembled with the reference gathered strand HS1. In addition, a register roller (actuator) V2, VN, which can be shifted in linear fashion in the direction of the arrow, is arranged in each of the two paths along which the individual gathered strands HS2, HSN to be adjusted travel.

The cutting register error or the positional information of the reference gathered strand HS1 or corresponding information is sent by the sensors S1A, S1 to a control unit ST, the cutting register error or corresponding positional information of the two individual gathered strands HS2, HSN to be adjusted is sent by the sensors S2, SN. From the deviation of the cutting register error (i.e., of the position) of the individual gathered strand HS2, HSN in question to be adjusted from the reference cutting register error (i.e., from the position of the reference gathered strand), actuating signals are calculated in the control unit, which are transmitted to the register rollers V2, VN or their linear drives to adjust the individual gathered strands HS2, HSN to be adjusted so that they match the reference value. Because the cutting register error of the individual gathered strands has been matched to the reference value, the resulting cutting register error of each of the individual gathered strands is therefore simultaneously the cutting register error of the complete gathered strand GHS and is brought by way of a control command to the drives M1, M2 of the cutting knife cylinder 12 and the draw rollers 11 into alignment with the cutting knife cylinder 12, for which purpose appropriate positioning signals are generated from the signal of the sensor S1.

Of course, deviations and modifications of the embodiments explained above are also possible without abandoning the scope of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for adjusting a cutting register in a folder of a web-fed rotary press having a folder superstructure, over which at least one gathered strand of a plurality of gathered strands which can be assembled into a complete gathered strand is guided, the method comprising:
acquiring information printed on an individual one of the plural gathered strands;
determining, based at least in part on the acquired information, a correction value for correcting a cutting register error of the individual one of the plural gathered strands; and
correcting the cutting register of the individual one of the plural gathered strands by at least one actuator associated with to the individual one of the plural gathered strands.

2. The method according to claim 1, further comprising
assembling the plural gathered strands into the complete gathered strand,
wherein the acquisition of the information and the correction of the cutting register error are performed after the strand has passed through the folder superstructure and before each of the plural gathered strands are assembled into the complete gathered strand.

3. The method according to claim 2, further comprising:
acquiring information printed on the complete gathered strand; and
correcting an overall cutting register of the complete gathered strand based at least in part on the acquired information printed on the complete gathered strand.

4. The method according to claim 2, further comprising:
acquiring information printed on each of the plural gathered strands except an individual one of the plural gathered strands on an outside of the complete gathered strand; and
determining at least one reference value from the information acquired from the complete gathered strand;
determining a correction value for each of the individual ones of the plural gathered strands as a deviation from the reference values based at least in part on the information acquired from the individual ones of the plural gathered strands; and
corrected cutting register error of the individual ones of the plural gathered strands based on the determined correction value.

5. The method according to claim 3, further comprising:
acquiring information printed each of the plural individual gathered strands;
determining reference values based at least in part on the information acquired from one of the individual gathered strands,
determining correction values as a deviation from the reference values for each of the plural individual gathered strands; and
correcting a cutting register error of an individual gathered strand based at least in part on the determined correction value for each of the plural individual gathered strands.

6. The method according to claim 5, further comprising
correcting an overall cutting register error of the complete gathered strand resulting from a deviation of the reference values from a nominal value of the overall cutting register of the complete gathered strand by at least one downstream actuator.

7. The method according to claim 4, wherein actuators for correcting the cutting register error of the individual gathered strand are provided only on the individual gathered strands from which printed information is acquired.

8. The method according to claim 1,
wherein said step of acquiring comprises acquiring information printed on all of the individual gathered strands;
providing an actuator for each individual gathered strand; and
calculating the correction values from a deviation of an actual value based at least in part on the acquired printed information from a presettable nominal value of a cutting register on a knife cylinder of the folder.

9. The method according to claim 1, wherein the cutting register error of the individual gathered strands is corrected by way of a change in the length of the web accomplished by a register roller configured to move in a linear guide.

10. The method according to claim 1, wherein a cutting register error of the complete gathered strand is corrected based at leased in part on a mean correction value determined from the correction values of the individual gathered strands.

11. The method according to claim 1, wherein information printed on an individual gathered strand is acquired from at least one of:
the individual gathered strands upstream of former lead-in rollers;
at least one partial web between a slitter and the former lead-in rollers; and
from a full web before it reaches the slitter.

12. The method according to claim 11, wherein an actuator downstream from the folder superstructure and assigned to one of an individual gathered strand and the complete gathered strand are corrected with adjusting signals based at least in part on preacquired printed information.

13. The method according to claim 12, further comprising determining, based at least in part on the preacquired information, whether or not to adjust the actuator downstream from the folder superstructure.

14. The method according to claim 11, further comprising determining, based at least in part on the preacquired information, adjustment limits for an adjustment of the actuator downstream from the folder superstructure.

15. The method according to claim 14, further comprising at least one of:
providing a first upstream actuator on at least one of the individual gathered strands in the area of the former lead-in rollers;
providing a second upstream actuator on at least one individual web between a slitter and the former lead-in rollers; and
providing a third upstream actuator on the full web,
wherein at least one of the first, second, and third upstream actuators is adjusted in based at least in part on the preacquired printed information such that an accumulated collected at that point is corrected.

16. The method according to claim 15, wherein the upstream actuator is configured as a drive for at least one of:
the former lead-in rollers,
draw rollers near the former lead-in rollers,
draw rollers between the slitter and the former lead-in rollers, and
draw rollers on the full web before the full web reaches the slitter,
wherein the a circumferential velocity of at least one of the draw rollers is adjusted based at least in part on the preacquired printed information.

17. The method according to claim 16, controlling the drive within predefined limits, the predefined limits being at least one of ±0.03% of a standard gain and any deviation from the standard gain is slowly reduced or an actual gain returned to the standard gain by a register roller capable of linear movement.

18. The method according to claim 1, wherein printed information is reacquired from the complete gathered strand in an area of a tucker blade cylinder and at least one of an angular position, gain, or rotational speed of the tucker blade cylinder is corrected by a drive of the tucker blade cylinder based at least in part on the reacquired printed information.

19. The method according to claim 18, wherein printed information is reacquired from the complete gathered strand in the area of a draw roller pair upstream of the tucker blade cylinder, and at least one of an angular position, gain, or rotational speed of the draw roller pair is corrected by a drive of the draw roller pair based at least in part on the reacquired printed information.

20. A web-fed rotary press comprising:
a folder;
a folder superstructure over which one or more individual gathered strands of a plurality of individual gathered strands which can be assembled into a complete gathered strand are guided;
a plurality of sensors configured to acquire information printed on at least one of gathered strands, a partial web, and the full web;
actuators for correcting the cutting register error of at least one of the complete gathered strand, the individual gathered strands, the partial web, and the full web; and
a control unit connected to the sensors and to the actuators,
wherein the control unit is configured to determine a correction value of at least one of the complete gathered strand, the individual gathered strands, the partial web, and the full web as a deviation from a reference value based at least in part on the information acquired from by the plural sensors.

21. The web-fed rotary press according to claim 20, further comprising register rollers provided as the actuators configured to move in linear guides for each of the individual gathered strands.

22. A web-fed rotary press according to claim 21, further comprising a regulating device configured as a register roller capable of linear movement, and installed upstream of at least one of the drive of folder lead-in rollers, draw-rollers near the former lead-in rollers, draw rollers between a slitter and the former lead-in rollers, and draw rollers on the full web before the full web reaches the slitter.

23. The method according to claim 2, further comprising:
acquiring information printed on the complete gathered strand; and
correcting an angular position of a cutting knife cylinder, based at least in part on the acquired information printed on the complete gathered strand.

24. The method according to claim 5, further comprising
correcting an overall cutting register error of the complete gathered strand resulting from a deviation of the reference values from a nominal value of the overall cutting register of the complete gathered strand by adjusting a drive of a cutting knife cylinder of the folder.
